(19) United States
(12) Patent Application Publication
(10) Pub. No.: US 2012/0190474 A1
(43) Pub. Date: Jul. 26, 2012

(54) GOLF CLUB, SHAFT INSERTION DEPTH CHANGING METHOD AND SHAFT REPLACING METHOD

(75) Inventor: Fumiaki Sato, Chichibu-shi (JP)

(73) Assignee: BRIDGESTONE SPORTS CO., LTD., Tokyo (JP)

(21) Appl. No.: 13/357,152

(22) Filed: Jan. 24, 2012

(30) Foreign Application Priority Data
Jan. 25, 2011 (JP) 2011-013034

(51) Int. Cl. A63B 53/02; B23P 17/00

(52) U.S. Cl. 473/305; 473/409; 29/402.08

(57) ABSTRACT

A golf club includes: a shaft; a head mounted on a leading end of the shaft; and a substantially cylindrical shaft case fixed to the leading end of the shaft, wherein: the shaft case is inserted into a hosel of the head; the shaft case is fixed to the head by a bolt inserted from a sole side of the head; and a spacer is interposed between an upper end of the hosel and a flange portion formed in an upper portion of the shaft case or is removed therefrom to change an insertion depth of the shaft case into the hosel.

### BACKGROUND

1. Field of the Invention

The present invention relates to a golf club and, specifically, it relates to a golf club capable of easy shaft replacement. Also, the invention relates to a method for changing the insertion depth of the shaft of such golf club and a method for replacing such shaft.

2. Description of the Related Art

In this golf, a head is mounted on the leading end portion of the shaft. A grip is mounted on the base end side of the shaft.

In an ordinary conventional golf club head, a hosel hole is formed directly in the head, while a shaft is inserted into the hosel hole and is fixed thereto with an adhesive. Here, as the adhesive, generally, there is used an epoxy system adhesive. To replace the shaft, the hosel portion may be heated to destroy its texture constituted of epoxy resin hardened material, whereby the shaft can be pulled out.

In such ordinary conventional golf club head, the insertion depth of the shaft cannot be changed.

As a golf club capable of changing the insertion depth of its shaft case, in the JP-A-2010-213859, there is disclosed a golf club in which a substantially cylindrical shaft case is fixed to the leading end of a shaft, the shaft case is inserted into the hosel of a head from the upper end side of the hosel, and the shaft case is fixed to the hosel by first and second annular screw members removably threadedly engaged with the upper end side of the hosel.

In the golf club of the above publication, a spacer is interposed between the lower end of the shaft case and the bottom portion of the hosel, a female screw is formed in the inner peripheral surface of the upper end side of the hosel, the first screw member is threadedly engaged with the upper end of the hosel coaxially with the hosel, a female screw is formed in the inner peripheral surface of the upper end side of the first screw member, and the male screw of the second screw member is threadedly engaged with the female screw of the first screw member. When the spacer and first screw member are removed and the second screw member is threadedly engaged directly with the female screw of the hosel, the insertion depth of the shaft can be increased.

The golf club of the above JP-A-2010-213859 requires multiple screw members and thus the composing members thereof are rather expensive.

### SUMMARY

The invention has an object to provide a golf club lower in the manufacturing cost, a method for changing the insertion depth of its shaft, and a method for replacing the shaft.

According to a first aspect of the invention, there is provided a golf club including: a shaft; a head mounted on a leading end of the shaft; and a substantially cylindrical shaft case fixed to the leading end of the shaft, wherein: the shaft case is inserted into a hosel of the head; the shaft case is fixed to the head by a bolt inserted from a sole side of the head; and a spacer is interposed between an upper end of the hosel and a flange portion formed in an upper portion of the shaft case or is removed therefrom to change an insertion depth of the shaft case into the hosel.

According to a second aspect of the invention, the golf club further includes a stopper portion for preventing the shaft case and spacer against rotation.

According to a third aspect of the invention, there is provided a method for changing the shaft insertion depth of a golf club including: a shaft; a head mounted on a leading end of the shaft; and a substantially cylindrical shaft case fixed to the leading end of the shaft, wherein: the shaft case is inserted into a hosel of the head; the shaft case is fixed to the head by a bolt inserted from a sole side of the head; and a spacer is interposed between an upper end of the hosel and a flange portion formed in an upper portion of the shaft case or is removed therefrom to change an insertion depth of the shaft case into the hosel, the method including: removing the bolt; pulling out the shaft case from the hosel; mounting or removing the spacer or replacing the spacer with another spacer having a different thickness; inserting the shaft case into the hosel; and fixing the hosel by the bolt.

According to a fourth aspect of the invention, in the above method, a weight adjusting portion is previously formed in the head; and the weight of the head can be adjusted according as the shaft insertion depth is changed.

According to a fifth aspect of the invention, there is provided a method for replacing the shaft of a golf club with a new shaft, the golf club including: a shaft; a head mounted on a leading end of the shaft; and a substantially cylindrical shaft case fixed to the leading end of the shaft, wherein: the shaft case is inserted into a hosel of the head; the shaft case is fixed to the head by a bolt inserted from a sole side of the head; and a spacer is interposed between an upper end of the hosel and a flange portion formed in an upper portion of the shaft case or is removed therefrom to change an insertion depth of the shaft case into the hosel, the method including: previously fixed a new shaft to a shaft case of a same type as the shaft case to provide a new shaft case/shaft connected member; removing a shaft case/shaft connected member mounted on the golf club from the head; and mounting the new shaft case/shaft connected member onto the head.

A golf club of the invention is capable of adjusting the insertion depth of the shaft case into the hosel. Therefore, in a golf club including quite the same head and shaft, simply by changing the shaft case insertion depth, a player can easily find out a golf club length suitable for the player.

In a golf club of the invention, the shaft case is inserted into the hosel hole and is fixed thereto by the bolt inserted from the sole side. This can eliminate the multiple annular screw members used in the JP-A-2010-213859 and thus can reduce the cost of the golf club.

In a golf club of the invention, by mounting or removing the spacer, or by replacing it with another spacer having a different thickness, the shaft insertion depth can be changed easily.

In a shaft replacing method of the invention, by loosening and removing the bolt, the shaft case can be pulled out from the hosel. When a new shaft case/shaft connected member with a shaft case previously mounted on a shaft is inserted into the hosel and the bolt is threadedly engaged with the connected member, the shaft replacement can be carried out.

This method can save conventionally necessary troublesome time and labor to heat and destroy the texture of the adhesive, remove an old shaft and mount a new shaft with an adhesive again. Therefore, the shaft case/shaft connected member can be removed from the head of a golf club just after end of test hitting, and another shaft case/shaft connected member having different characteristics can be mounted on this head and the golf club can be used immediately for next test hitting. This allows a golfer to find out a proper golf club in a golf shop or the like quite easily.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a front view of a head according to an embodiment;

FIG. 2 is a side view of the heel side of the head;

FIG. 3 is a section view taken along the 111-111 line shown in FIG. 1;

FIG. 4 is an exploded perspective view of a golf club;

FIG. 5 is an exploded perspective view of a hosel, a spacer and a shaft case;

FIG. 6 is an exploded perspective view of a hosel, a spacer and a shaft case included in another embodiment; and

FIG. 7 is an exploded perspective view of a weight adjusting portion.

### DETAILED DESCRIPTION OF THE INVENTION

Now, description will be given below of the embodiments of the invention with reference to the accompanying drawings.

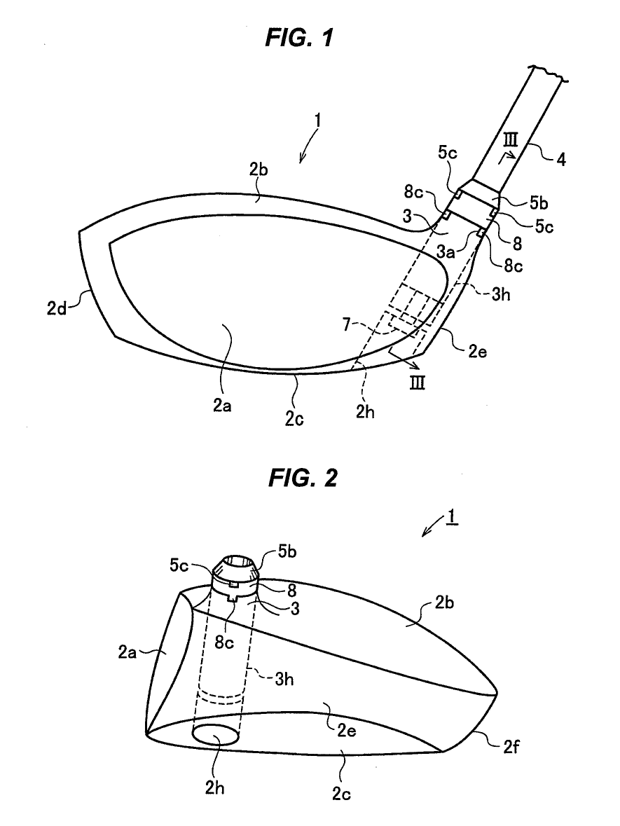

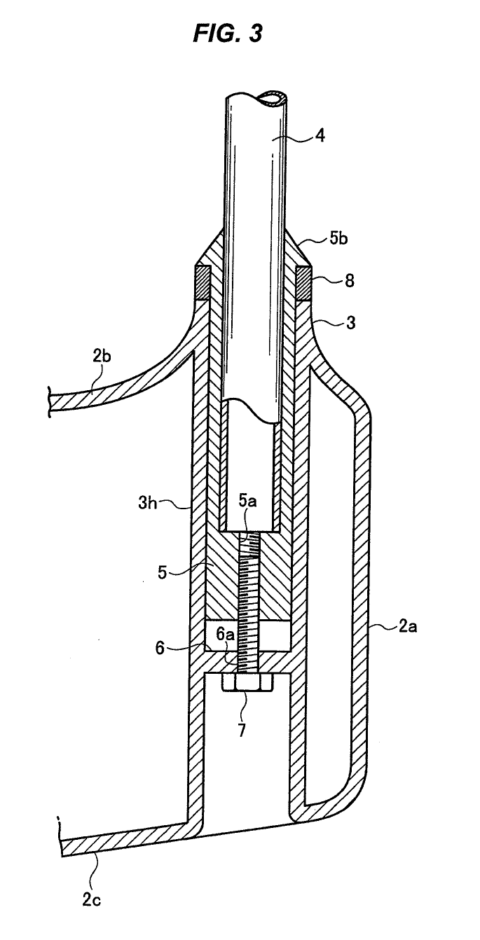

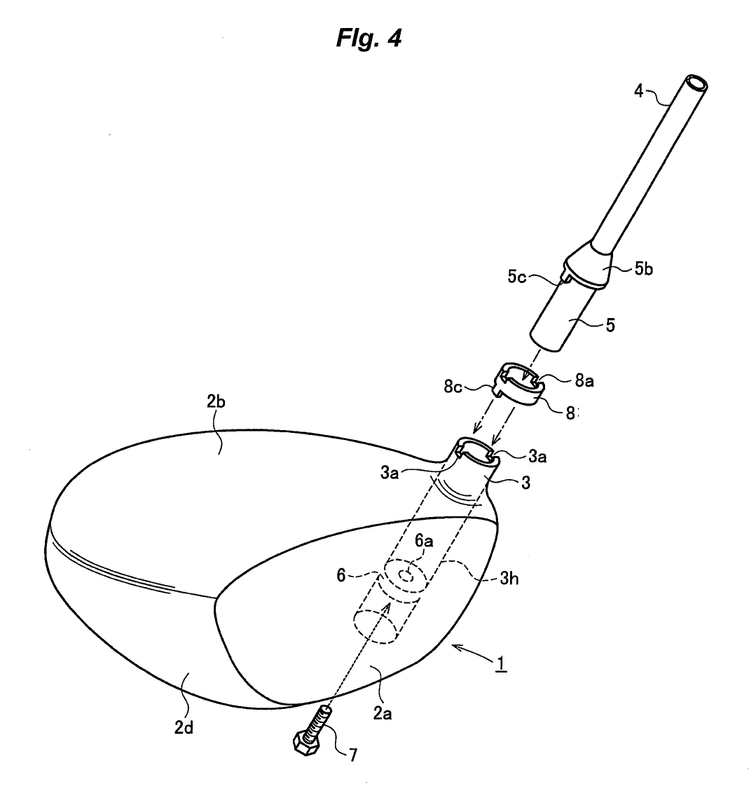

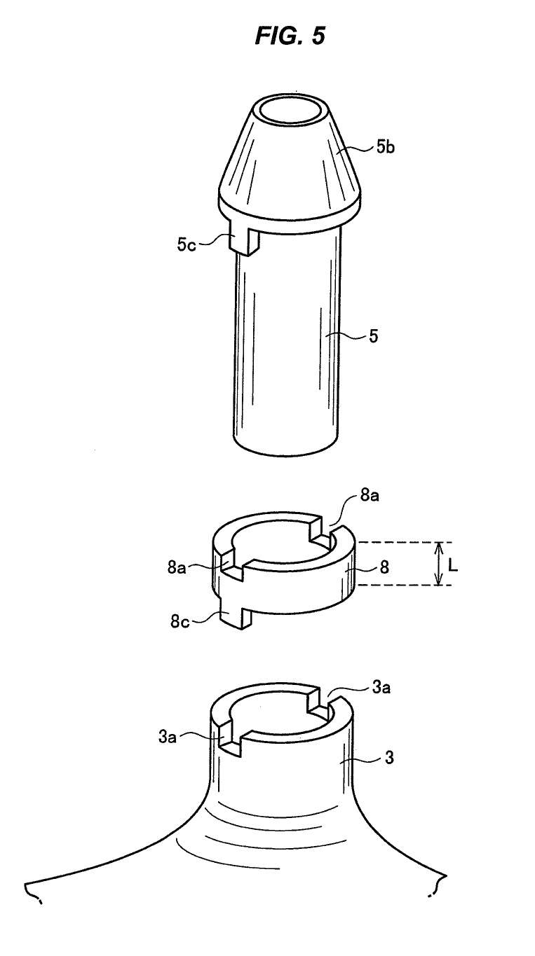

FIG. 1 is a front view of the head neighboring portion of a golf club according to the first embodiment, FIG. 2 is a side view of the heel side of the golf club head. FIG. 3 is a section view taken along the III-III line shown in FIG. 1, FIG. 4 is an exploded perspective view of the golf club, and FIG. 5 is an exploded perspective view of a hosel, a spacer and a shaft case.

In this golf club, a shaft 4 is mounted on the hosel 3 of a head 1 through a shaft case 5, a spacer 8 and a bolt 7.

The head 1 is hollow for a wood club and includes a face portion 2a, a crown portion 2b, a sole portion 2c, a toe portion 2d, a heel portion 2e and a back portion 2f.

As shown in FIG. 3, the hosel 3 is disposed on the face portion 2a side and heel portion 2e side of the crown portion 2b. A tubular portion 3h having the same inside diameter as the hosel 3 extends along and coaxially with the hosel 3 up to the sole portion 2c. The shaft case 5 is inserted into this tubular portion 3h and is fixed thereto by the bolt 7. The tubular portion 3h includes a partition plate section 6 extending perpendicularly to the axial direction of the tubular portion 3h. The bolt 7 is inserted upwardly from below through an opening 6a formed in this partition plate section 6 and is screwed into the female screw hole 5a of the shaft case 5.

As shown in FIGS. 4 and 5, the shaft case 5 is a cylindrical member having a diameter slightly smaller than that of the tubular portion 3h and includes a hole for insertion of the shaft 4 extending from the upper end side of the shaft case 5 toward the lower end side. The shaft 4 is inserted into this hole and is fixed to the shaft case 5 with an adhesive. The depth of this hole, preferably, may be 10 mm or more, for example, 10˜50 mm, especially, about 20˜40 mm. The female screw hole 5a extends from the deep bottom surface of this hole to the lower end face of the shaft case 5.

The shaft case 5 includes an outward facing collar-shaped flange portion 5b formed in its upper end. The upper surface of the flange portion 5b has a taper shape the diameter of which decreases as it goes upward. However, this is not limitative.

An annular spacer 8 is interposed between the upper end of the hosel 3 and flange portion 5b. By removing the spacer 8 or by replacing it with another spacer 8 having a different thickness L, the insertion depth of the shaft case 5 into the tubular portion 3h can be changed, whereby the length of the golf club can be adjusted.

Here, as a stopper portion for preventing the rotation of the spacer 8 and shaft case 5 on their respective axes, there are formed a recessed portion 3a in the upper end of the hosel 3 and a projecting portion 8c on the lower surface of the spacer 8, while the recessed portion 3a and projecting portion 8c are engaged with each other. Also, as a stopper portion, there are formed a recessed portion 8a in the upper end face of the spacer 8 and a projecting portion 5c on the lower surface of the flange portion 5b, while the recessed portion 8a and projecting portion 5c are engaged with each other. When the spacer 8 is removed, the projecting portion 5c of the shaft case 5 is engaged with the recessing portion 3a of the hosel 3.

To assemble the golf club, as shown in FIG. 4, the shaft case 5 may previously fixed to the leading end of the shaft 4 with an adhesive to thereby provide a shaft case/shaft connected member. Preferably, this adhesive may be applied to the outer peripheral surface of the leading end portion of the shaft 4 and the shaft 4 may be inserted down to the deepest portion of the hole 5a of the shaft case 5.

Here, due to formation of the female screw hole 5a in the shaft case 5, when the shaft 4 is inserted into the hole 5a of the shaft case 5, the air is allowed to flow out through such female screw hole 5a. As the adhesive, preferably, an epoxy adhesive or the like may be used.

The spacer 8 is fitted with the outer surface of the shaft case 5. The shaft case 5 of the shaft case/shaft connected member with the spacer 8 is inserted into the hosel 3. The projecting portion 5c and recessed portion 8a are engaged with each other, the projecting portion 8c and recessed portion 3a are engaged with each other, and the bolt 7 is screwed into the female screw hole 5a through the opening 6a.

Thus, as shown in FIG. 3, the shaft case 5 is fixed to the head 1. Since the shaft case 5 and shaft 4 are firmly bonded to each other with an adhesive, there is completed a golf club constituted of the shaft 4 and head 1 formed as a body.

To increase the insertion depth of the shaft 4, as described above, the spacer 8 may be removed or may be replaced with another spacer 8 having a small thickness L (FIG. 5). Of course, when the spacer 8 is replaced with another spacer 8 having a large thickness L, the insertion depth of the shaft 4 can be reduced. In this manner, by changing the insertion depth of the shaft 4 into the hosel 3, the length of the golf club 1 can be changed.

To replace the shaft of the golf club, a shaft case of the same type as the shaft case 5 may be previously fixed to a new shaft to replace with an adhesive.

The bolt 7 of the existing golf club is removed and the old shaft 4 is removed from the head 1 together with the old shaft case 5. Next, the new shaft with a shaft case (a shaft case/shaft connected member) is inserted into the head 1 and fixed by the bolt 7.

Thus, the mounting and replacement of the shaft can be carried out very simply and quickly. Here, conventionally, in the shaft replacement, the hosel portion of an existing golf club is heated to destroy the texture of the hardened adhesive resin and, after removal of the old shaft, a new shaft is fixed with an adhesive, which takes several hours to about one day. On the other hand, in the above embodiment, since the shaft case 5 is previously mounted on the new shaft with an adhesive, the shaft replacement can be completed in about several minutes. Therefore, there can be realized a use system in which shafts each with a shaft case of various specifications can be prepared and a golfer can mount different shafts sequentially on the same head 1 for test hitting.

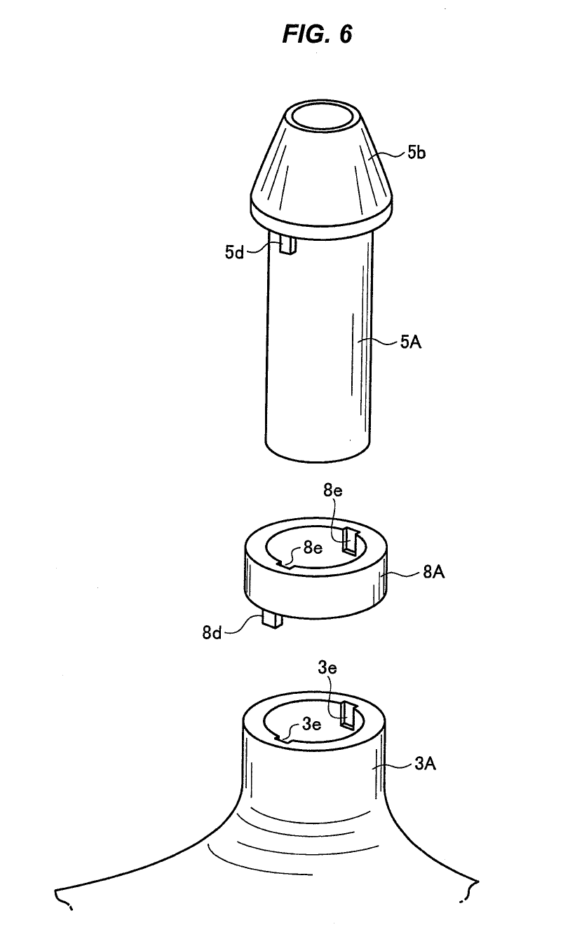

In this embodiment, the recessed portions 3c, 8a and projecting portions 8c, 5c to prevent the spacer 8 and shaft case 5 against rotation are respectively formed in the end faces of the spacer 8 and flange portion 5b. However, as in a hosel 3A, spacer 8A and shaft case 5A shown in FIG. 6, recessed strip portions 3e, 8e may also be formed in the inner peripheral surfaces of the hosel 3A and spacer 8A, a projecting portion 8d may be provided on the inner peripheral side of the lower end face of the spacer 8A, and a projecting strip portion 5d may be provided on the outer peripheral surface of the shaft case 5A.

The shaft case and bolt may preferably be made of metal, especially, aluminum or titanium or an alloy thereof.

The material of the head is not limited to a specific material. However, in the case of a golf club head of a wood type, for example, a titanium alloy, an aluminum alloy, stainless steel or the like can be used.

In this invention, as described above, the shaft insertion depth can be changed by removing the spacer or replacing it with another spacer having a different thickness, thereby changing the length of the golf club. Thus, by mounting or removing the spacer or replacing it to change the length of the golf club, the weight or center of gravity of the head and the balance of the golf club are caused to change. Thus, in this invention, preferably, a weight adjusting portion may be formed in the head. Specifically, for example, when weight adjusting screw holes are formed in the sole portion, back portion and side portion of the golf club head and screws having different weights are mounted into them, the weight of the head can be adjusted. When there are used screws having different lengths and made of different material (for example, resin such as nylon, aluminum, magnesium, titanium, alloys thereof, stainless steel, a tungsten alloy), the head weight can be adjusted.

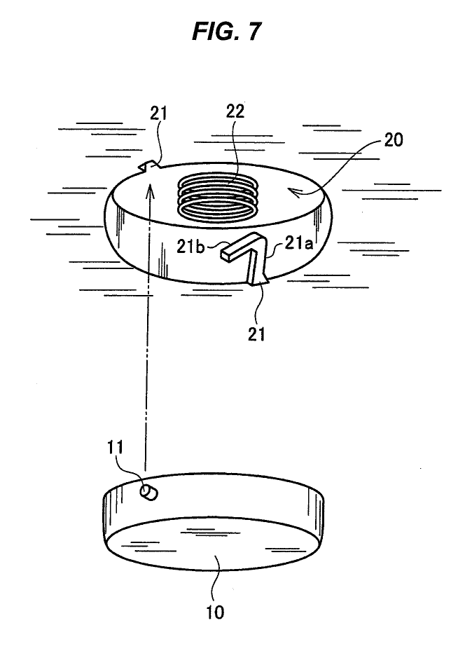

Instead of the screws, as shown in FIG. 7, a weight may be removably mounted into the recessed hole portion 20 of the head using a key and a key groove.

The weight 10 has a disk shape and includes a key 11 provided on its outer peripheral surface and projected in its diameter direction. The recessed hole portion 20 has a circular shape and includes a key groove 21 in its inner peripheral surface. This key groove 21 has a substantially L-like shape including a vertical bar portion 21a extending in the depth direction of the recessed hole portion 20 and a horizontal bar portion 21b ranging from the leading end side of the vertical bar portion 21a.

Here, the horizontal bar portion 21b intersects the vertical bar portion 21a at an angle smaller than 90° and, accurately, the shape of the key groove 21 is not “L” but “ [symbol] ”. A spring 22 is provided on the upper surface of the weight 10 or on the deep bottom surface of the recessed hole portion 20, while the weight 10 is inserted into the recessed hole portion 20 while compressing the spring 22. When the key 11 reaches the leading end of the vertical bar portion 21a, the weight 10 is turned to guide the key 11 into the horizontal bar portion 21b. Due to the pressure of the spring 22, the key 11 is retained in the horizontal bar portion 21b and the weight 10 is firmly retained within the recessed hole portion 20.

Although, in the above embodiment, the golf club head is of a wood type, the invention can also be applied to golf club heads of all of utility type, iron type and putter type.

What is claimed is:

1. A golf club comprising:
a shaft;
a head mounted on a leading end of the shaft; and
a substantially cylindrical shaft case fixed to the leading end of the shaft, wherein:
the shaft case is inserted into a hosel of the head;
the shaft case is fixed to the head by a bolt inserted from a sole side of the head; and
a spacer is interposed between an upper end of the hosel and a flange portion formed in an upper portion of the shaft case or is removed therefrom to change an insertion depth of the shaft case into the hosel.

2. The golf club according to claim 1, further comprising a stopper portion for preventing the shaft case and spacer against rotation.

3. A method for changing the shaft insertion depth of a golf club including: a shaft; a head mounted on a leading end of the shaft; and a substantially cylindrical shaft case fixed to the leading end of the shaft, wherein: the shaft case is inserted into a hosel of the head; the shaft case is fixed to the head by a bolt inserted from a sole side of the head; and a spacer is interposed between an upper end of the hosel and a flange portion formed in an upper portion of the shaft case or is removed therefrom to change an insertion depth of the shaft case into the hosel, the method comprising:
removing the bolt;
pulling out the shaft case from the hosel;
mounting or removing the spacer or replacing the spacer with another spacer having a different thickness;
inserting the shaft case into the hosel; and
fixing the head by the bolt.

4. The method according to claim 3, wherein:
a weight adjusting portion is previously formed in the head; and
the weight of the head can be adjusted according as the shaft insertion depth is changed.

5. A method for replacing the shaft of a golf club with a new shaft, the golf club including: a shaft; a head mounted on a leading end of the shaft; and a substantially cylindrical shaft case fixed to the leading end of the shaft, wherein: the shaft case is inserted into a hosel of the head; the shaft case is fixed to the head by a bolt inserted from a sole side of the head; and a spacer is interposed between an upper end of the hosel and a flange portion formed in an upper portion of the shaft case or is removed therefrom to change an insertion depth of the shaft case into the hosel, the method comprising:
previously fixed a new shaft to a shaft case of a same type as the shaft case to provide a new shaft case/shaft connected member;
removing a shaft case/shaft connected member mounted on the golf club from the head; and
mounting the new shaft case/shaft connected member onto the head.
